(19) United States
(12) Patent Application Publication
(10) Pub. No.: US 2006/0107121 A1
(43) Pub. Date: May 18, 2006

(54) Method of speeding up regression testing using prior known failures to filter current new failures when compared to known good results

(75) Inventors: Daniel Mendrala, Charlton, MA (US); May-Ling Mendrala, Charlton, MA (US)

Correspondence Address: RICHARD M. GOLDMAN, 371 ELAN VILLAGE LANE, SUITE 208, CA, 95134, US

(73) Assignee: International Business Machines Corporation, Armonk, NY (US)

(21) Appl. No.: 10/972,683

(22) Filed: Oct. 25, 2004

(51) Int. Cl. G06F 11/00

(52) U.S. Cl. 714/38

(57) ABSTRACT

A method, system, and program product for regression testing computer code. The first step is regression testing is providing a regression test of a pre-change body of computer code, where the regression test of the pre-change code has known failures. The main body of code, that is the changed and upgraded body of code, is regression tested after changes have been entered. Failures are detected, including both new failures and known failures. The new failures are filtered against known failures, and the new failures are analyzed to determine which are actual failures and which are apparent failures.

### BACKGROUND

1. Technical Field

The invention relates to automated testing systems for software and to automated testing of software for changes

2. Description of Related Art

The various activities which are undertaken when developing software are commonly modeled as a software development lifecycle. The software development lifecycle begins with the identification of a requirement for software and generally ends with the formal verification of the developed software against that requirement.

The software development lifecycle does not exist by itself; it is in fact part of an overall product lifecycle. Within the product lifecycle, software will undergo maintenance to correct errors and to comply with upgrade, patch, and maintenance type changes to requirements.

This is so because successfully developed software will become part of a product and the product will enter a maintenance phase. During the maintenance phase the software undergoes modifications to correct errors and to comply with changes in requirements. Like the initial development stage, subsequent modifications in the maintenance phase follow a software development lifecycle model, but not necessarily the same lifecycle model as the initial software development.

Changes to software are generally unavoidable. Eventually the need arises to amend software, either to correct defects or to modify functionality, and those changes may be required at short notice.

Irrespective of the lifecycle model used for software development, software has to be to modified, revised, patched, changed, and then tested. Efficiency and quality are best served by testing software as early in the lifecycle as practical, with full regression testing whenever changes are made.

The term regression testing is used to refer to the repetition of earlier successful tests in order to make sure that changes to the software have not introduced side effects.

Regression analysis is the retesting, and particularly the selective retesting, of a software system that has been changed. The purpose of regression of analysis is to ensure that any bugs have been fixed and that no previously working functions have failed as a result of the changes, and that newly added features have not created problems with previous versions of the software. Regression testing is initiated after a programmer has attempted to fix a recognized problem or has added source code to a program, where the fix itself may have inadvertently introduced errors.

There are many different models for software development lifecycles. One thing which all models have in common is that at some point in the lifecycle, software has to be tested.

To remain competitive, software developers must be able to implement changes to software quickly and reliably. There is no challenge to making changes quickly. The problem is making changes reliably, and doubts about the reliability of the changes must be dispelled with proof. To remove doubts while supporting rapid change, testing must therefore be both thorough and quick, leaving little option but to automate the testing process.

Throughout the maintenance phase, software tests have to be repeated, modified and extended in consonance with modifications and changes in the actual code of the underlying software product. The effort to revise and repeat tests forms a major part of the overall effort associated with developing and maintaining software.

Successful integration of automated regression testing tools into the development process provides greater levels of confidence that changes introduced into software will be tested and they will be less likely to cause unexpected bugs and failures when the software is later shipped to users.

Making changes to software which is in a known state can, and often does, pose a serious threat to that known state. Even the smallest change can render software inoperable if the effects of the change were not properly understood or if the change was insufficiently tested during and after implementation.

Whenever a developer modifies a unit or component of a software program and the unit or component interacts with other components, it is generally necessary to do regression testing by rerunning the existing tests against the modified code. This is necessary in order to determine whether the changes break existing functions. Comprehensive testing of existing system is a common mistake and waste of time. It may fail to detect the bugs because the lack of detailed testing on the problematic pieces. Regression testing should focus the modified component and the components that interact with the modified component.

When running automated regression testing, differences between known good logs (“gold logs”) and the current run are automatically flagged as failures and then these differences must be manually analyzed to make sure the change is expected. If the change is expected, then the user replaces the “gold log” with the new log, thereby accepting the change. If the change is not expected, the user can either:
a. Replace the “gold log” with the current log and mark a tracking field (“Problem Field”) with the problem report (“Problem Field”) and re-run the test, resulting in the test now passing. Note that the “gold log” now has the changed “incorrect” information in it and it will pass future runs until the problem noted in the “Problem Field” is resolved at which time the test will fail again. This reduces the number of failures but results in possible loss of information because the good “gold log” is now replaced with “bad” information and it may be difficult to make sure that when the problem is fixed the new results are actually correct.
b. Keep the test as a “failure”. This will result in failures appearing in automation runs until the problem or failure in the “Problem Field” is resolved and the failure disappears. Doing this helps to make sure that the problem is fixed correctly, however this “failure” will now appear in every run and it must be checked in every run to ensure something different has not happened in the test because of other changes.

Due to the volume of testing performed it becomes difficult to keep track of all of the changes and to make sure that the problems are fixed correctly. Thus, a need exists for managing “failures” until a “fix” is implemented.

### SUMMARY OF THE INVENTION

The problem of managing and tracking reported “failures” until a “fix” is implemented is obviated by the method, system, and program product described herein. Described herein is automated regression analysis testing of software changes with management of reported “failures”, with the “failures” flagged and logged, through successive tests until a “fix” is implemented.

According to our invention, management of “failures” is accomplished through successive tests until a “fix” is implemented by first providing a regression test of a pre-change body of computer code. The log of this regression test or tests show known failures. Next, the body of computer code, after modifications and changes, is regression tested, that is, after changes have been entered. The failures are detected. The detected failures are substantially all of the failures, including both new failures (the likely consequences of changes) and known and apparent failures from previous tests. Finally, the new failures, that is, the failures introduced since the last regression test by the maintenance process, are filtered through the set of known failures.

The method, system, and program product described herein uses existing methods to look for failures (comparing known good “gold logs” against the current run). But, when a failure is detected, that is, when the comparison with the “Gold Log” fails, the system will compare the “current log” against the “known failure” log (if available). If the differences between the logs match then this failure would be flagged as a “failure-known”, otherwise it is marked as a “failure”.

The agent or person responsible for validating the failures would then be able to skip the “failure-known” tests, that is, failures that had been found in previous tests, and concentrate on the newly discovered failures and resolve them in one of three ways:
a. If the failure is now showing the new and correct behavior, it can be copied into the “gold log” and when retested this will “pass”.
b. If the failure is caused by a new problem, the “current log” can be saved in the “known failure” log, a defect entered to resolve the issue, and the test automatically marked “failure-known” so future runs will not need to be re-analyzed.
c. If unable to determine what is wrong the test can be left in the “failure” state.

The advantages of using this method are:
a. “Know failures” are automatically flagged so that they do not need to be re-checked every run.
b. New failures are still identified, since the “gold logs” are not updated with “bad” data.
c. The validity of “gold logs” is not compromised by replacement of data to make tests “pass”. Depending on the complexity of the test, when a “gold log” is replaced just to make the test pass, it may be very difficult to determine later what the expected results really were for the test; for example, people knowledgeable about the test may no longer be working on the project.
d. Regression testing can be performed much faster.

### BRIEF DESCRIPTION OF THE DRAWINGS

FIG. 1 illustrates a flow chart for a method of carrying out the invention.

### DETAILED DESCRIPTION

The nature, objectives, and advantages of the invention will become more apparent to those skilled in the art after considering the following detailed description in connection with the accompanying drawings.

The method, system, and program product described herein relates to automated testing of software for changes

As used herein certain terms have the following meanings.

“Gold Log”—The Gold Log is the log that is saved in every regression test document and contains the expected “good” results for the test.

“CurrentLog”—The CurrentLog is the log that is saved in every regression test document that contains the current results for the test.

“BadLog”—The BadLog is the log that is optionally saved in every regression test document containing the “bad” results that have been analyzed and are in a “known” bad result state

According to our invention multiple logs are created. One log is the “Gold Log” for a previous test of the code, and the other log or logs are the “CurrentLog” and, optionally, the “BadLog.” The “GoldLog” and the “CurrentLog” are compared in a search for apparent failures, including both new failures (the possible result of changes in the code) and old failures (i.e., previously known failures arising before the current code changes).

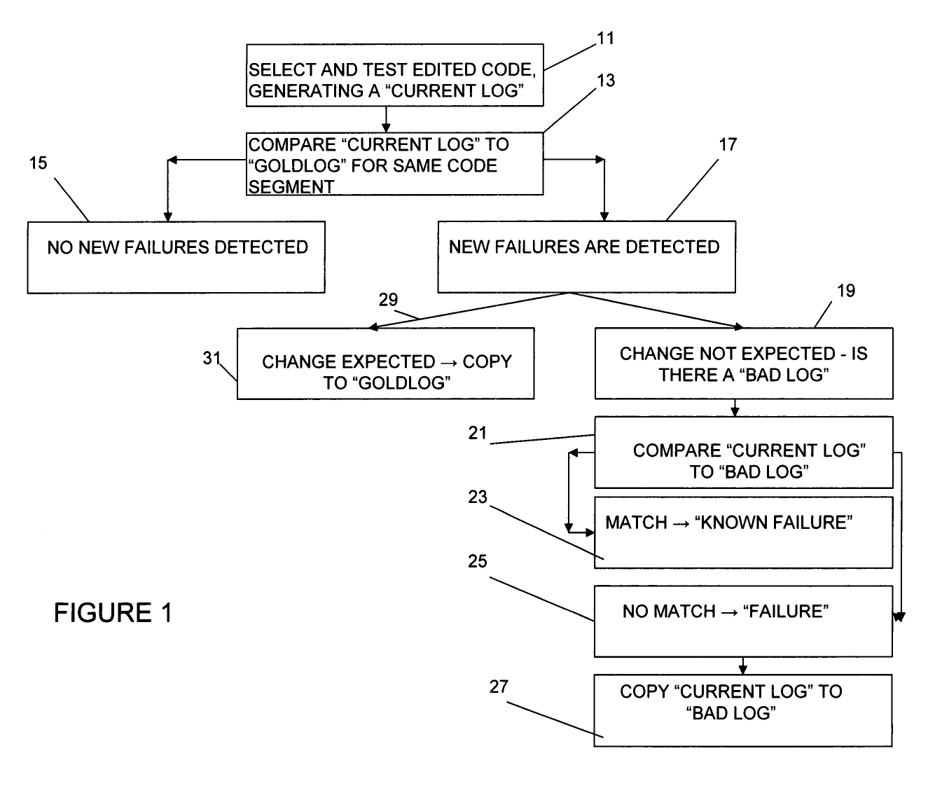

The method of our invention may be implemented using existing testing structure. One implementation is illustrated in the flowchart of FIG. 1. As shown in FIG. 1, the following steps are carried out.

As a first step, element 11 in FIG. 1, a segment of computer code is selected for regression testing. A regression test is run on the code segment to generate a “CurrentLog” for the code segment.

This newly generated “CurrentLog” is compared to the previously generated “GoldLog” for the prior state of the code segment (i.e., before modification).for the computer code tested to the “CurrentLog” for the code segment, element 13 of FIG. 1.

If the logs are a match, that is, no new failures are detected, then the test is marked “pass” and deemed completed. This is represented by element 15 of FIG. 1. If, however, the logs are not a match, element 17 of FIG. 1, a determination is made if a “BadLog” exists, element 19 of FIG. 1. If the log does exist then this log is compared to the “CurrentLog”, as illustrated by element 21 of FIG. 1. If these two logs match then the test is marked “failure-known” as shown in element 23. Otherwise the test is marked “failure” as shown by element 25. The test marked “failure” is used to make a determination of the test results.

If the test results are “good”, as shown in element 29, meaning that the change was expected, then the “CurrentLog” is copied into the “GoldLog” as shown in element 31. In this case the system should NOT update the test status to “pass”. The test should be re-run to make sure it now passes.

If the test results are “bad”, meaning that the change was not as expected, then the “CurrentLog” is copied into the “BadLog” as shown in element 27. The system can then set the results to “failure-known.” A problem report should be entered into a tracking system so that this issue will get resolved; for example, when the test is run after the problem is fixed, and the results entered into the “GoldLog” which will match the “CurrentLog” and the test will pass.

If the test results are unable to be analyzed, or need to be analyzed by someone else, then nothing can be done and the test will be remain in the “failure” state, as shown in element 23.

An advantage of placing the “BadLog” in the test document is that when our databases are copied, each one will contain the “known failures” at that point in time. As the test databases diverge (for example, when a new code stream is introduced) each database will become more specific to each code stream.

Program Product

The invention may be implemented, for example, by having the system for detecting “failures” in edited and changed coded by creating multiple logs, where one log is the “Gold Log” for a previous test of the code, and the other log or logs are the “CurrentLog” and, optionally, the “BadLog” for the changed code, where the “GoldLog” and the “CurrentLog” are compared in a search for apparent failures, including both new failures (the possible result of changes in the code) and old failures (i.e., previously known failures arising before the current code changes) with appropriate entries. This may be a software application (such as an operating system element), code running on a dedicated processor, or a dedicated processor with dedicated code.

The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for managing apparent failures in edited or otherwise changed code. The code may be a software application (such as an operating system element), or code embedded in a dedicated processor, or a dedicated processor with dedicated code.

This signal-bearing medium may comprise, for example, memory in a server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable files, script files and wizards for installation, as in Zip files and cab files. As used herein the term machine-readable instructions or code residing in or on signal-bearing media include all of the above means of delivery.

### Other Embodiments

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

We claim:

1. A method of regression testing computer code comprising:
a) providing a regression test of a pre-change body of computer code, said regression test having known failures;
b) regression testing the body of computer code after changes have been entered and detecting failures including new failures and known failures; and
c) filtering new failures against known failures.

2. The method of claim 1 comprising:
a) providing a regression test of a pre-change body of computer code, said regression test comprising a gold log having known apparent failures;
b) regression testing the body of computer code after changes have been entered and detecting failures as a current log having new failures and known failures;
c) filtering new failures against known apparent failures;
d) analyzing the new failures to determine which are actual failures and which are apparent failures.

3. The method of claim 2 comprising saving actual failures in a log of known failures.

4. The method of claim 2 comprising saving apparent failures which are not actual failures into a gold log.

5. A program product tangibly embodying computer readable program code executable by a digital processing apparatus to control a computer to perform a method for regression analysis of computer code, said method comprising
a) providing a regression test of a pre-change body of computer code, said regression test having known failures;
b) regression testing the body of computer code after changes have been entered and detecting failures including new failures and known failures; and
c) filtering new failures against known failures.

6. The program product of claim 5, wherein said method comprises:
a) providing a regression test of a pre-change body of computer code, said regression test comprising a gold log having known apparent failures;
b) regression testing the body of computer code after changes have been entered and detecting failures as a current log having new failures and known failures;
c) filtering new failures against known apparent failures:
d) analyzing the new failures to determine which are actual failures and which are apparent failures.

7. The program product of claim 6 wherein said method comprises saving actual failures in a log of known failures.

8. The program product of claim 6 wherein said method comprises saving apparent failures which are not actual failures into a gold log.

9. A computer system adapted for editing and analyzing computer program code by a method comprising:
a) providing a regression test of a pre-change body of computer code, said regression test having known failures;
b) regression testing the body of computer code after changes have been entered and detecting failures including new failures and known failures; and
c) filtering new failures against known failures.

10. The computer system of claim 9, wherein said method comprises:
a) providing a regression test of a pre-change body of computer code, said regression test comprising a gold log having known apparent failures;
b) regression testing the body of computer code after changes have been entered and detecting failures as a current log having new failures and known failures;
c) filtering new failures against known apparent failures;
d) analyzing the new failures to determine which are actual failures and which are apparent failures.

11. The computer system of claim 10 wherein said method comprises saving actual failures in a log of known failures.

12. The computer system of claim 10 wherein said method comprises saving apparent failures which are not actual failures into a gold log.
